(19) United States
(12) Patent Application Publication
(10) Pub. No.: US 2013/0070999 A1
(43) Pub. Date: Mar. 21, 2013

(54) ULTRASOUND SYSTEM AND METHOD FOR PROVIDING COLOR RECONSTRUCTION IMAGE

(71) Applicant: Yun Hee Lee, Seoul (KR)

(72) Inventor: Yun Hee Lee, Seoul (KR)

(73) Assignee: SAMSUNG MEDISON CO., LTD., Kangwon-do (KR)

(21) Appl. No.: 13/700,389

(22) PCT Filed: May 26, 2011
(86) PCT No.: PCT/KR11/03868

§ 371 Date: Nov. 27, 2012

(30) Foreign Application Priority Data
May 27, 2010 (KR) 10-2010-0049580

(51) Int. Cl. G06K 9/00

(52) U.S. Cl. 382/131

(57) ABSTRACT

There is disclosed an embodiment for providing a color reconstruction image. An ultrasound data acquisition unit transmits a ultrasound signal to a target object and receive an echo signal reflected from the target object to acquire ultrasound data. A user interface receives input information from a user. A processor is in communication with the ultrasound data acquisition unit and the user interface. The processor is configured to form a color Doppler mode image and a color map by using the ultrasound data, detects pixels corresponding to colors within a region of interest set in the color map from the color Doppler mode image based on the input information and forms a color reconstruction image represented by the colors corresponding to the detected pixels.

### TECHNICAL FIELD

The present invention generally relates to ultrasound systems, and more particularly to an ultrasound system and method for providing a color reconstruction image.

### BACKGROUND ART

An ultrasound system has become an important and popular diagnostic tool due to its non-invasive and non-destructive nature. The ultrasound system can provide high dimensional real-time ultrasound images of inner parts of target objects without a surgical operation.

The ultrasound system transmits ultrasound signals to the target objects, receives echo signals reflected from the target objects and provides color Doppler mode images of the target objects based on the echo signals. In the color Doppler mode images, velocities of the target objects (e.g., blood flows) that flow toward an ultrasound probe are represented by a first color (e.g., red), while velocities of the target objects that flow away from an ultrasound probe are represented by a second color (e.g., blue). Furthermore, the ultrasound system provides a color map, which indicates the velocities of the target objects in terms of colors, to indicate the relative velocities of the target objects in the color Doppler mode images. The color map is divided into an upper part and a lower part with respect to the zero baseline, which indicates that the velocity of the target object is zero. The upper part is represented by the first color and the lower part is represented by the second color. The first and second colors are represented by darker shades of the first or second color close to the zero baseline and represented by brighter shades of the first or second color away from the zero baseline. Aforesaid variance of colors is to represent velocity variance of the target objects. The brighter hues of the first or second color represent the relatively faster velocities of the target objects, while the darker hues of the first and second color represent the relatively slower velocities of the target object in the color map. The color map may be set to various types and styles by a user.

Conventionally, the ultrasound system may not provide functions of setting a specific region in the color map and providing a color Doppler image represented by colors corresponding to the specific region. Thus, an ultrasound system capable of providing the color Doppler image represented by colors corresponding to the specific region set by the user is needed for user convenience.

### DISCLOSURE OF INVENTION

### Technical Problem

The present invention generally relates to an ultrasound system and method for providing a color reconstruction image.

Solution to Problem

An embodiment for providing a color reconstruction image is disclosed herein. In one embodiment, by way of non-limiting example, there is provided an ultrasound system, comprising: an ultrasound data acquisition unit configured to transmit a ultrasound signal to a target object and receive an echo signal reflected from the target object to acquire ultrasound data; a user interface configured to receive input information from a user; and a processor in communication with the ultrasound data acquisition unit and the user interface, the processor being configured to form a color Doppler mode image and a color map by using the ultrasound data, detect pixels corresponding to colors within a region of interest set in the color map from the color Doppler mode image based on the input information and form a color reconstruction image represented by the colors corresponding to the detected pixels.

In another embodiment, there is provided a method of providing a color reconstruction image, comprising: a) acquiring ultrasound data of a target object; b) forming a color Doppler mode image and a color map by using the ultrasound data; c) receiving input information from a user; d) detecting pixels corresponding to colors within a region of interest set in the color map from the color Doppler mode image based on the input information; and e) forming a color reconstruction image represented by the colors corresponding to the detected pixels.

In yet another embodiment of the present invention, there is provided a computer readable medium having instructions that, when executed by a processor performs a color reconstruction image providing method of an ultrasound system, cause the processor to perform steps, comprising: a) acquiring ultrasound data of a target object; b) forming a color Doppler mode image and a color map by using the ultrasound data; c) receiving input information from a user; d) detecting pixels corresponding to colors within a region of interest set in the color map from the color Doppler mode image based on the input information; and e) forming a color reconstruction image represented by the colors corresponding to the detected pixels.

### Advantageous Effects of Invention

The present invention provides functions of setting a specific region in the color map and providing a color Doppler image represented by colors corresponding to the specific region. Thus, the ultrasound system of the present invention is capable of providing information, which a user wants and controlling a position and size of the specific region in real time.

### BRIEF DESCRIPTION OF DRAWINGS

FIG. 1 is a block diagram showing an illustrative embodiment of an ultrasound system.

FIG. 2 is a schematic diagram showing an illustrative embodiment of displaying a B-mode image, a color map and regions of interest.

FIG. 3 is a block diagram showing an illustrative embodiment of an ultrasound data acquisition unit of FIG. 1.

FIG. 4 is a block diagram showing an illustrative embodiment of a processor of FIG. 1.

FIG. 5 is a schematic diagram showing an illustrative embodiment of displaying a B-mode image, a color Doppler mode image and a color map.

FIG. 6 is a schematic diagram showing an illustrative embodiment of displaying a B-mode image, a color reconstruction image and a color map.

### MODE FOR THE INVENTION

This detailed description is provided with reference to the accompanying drawings. One of ordinary skill in the art may realize that the following description is illustrative only and is not in any way limiting. Other embodiments of the present invention may readily suggest themselves to such skilled persons having the benefit of this disclosure.

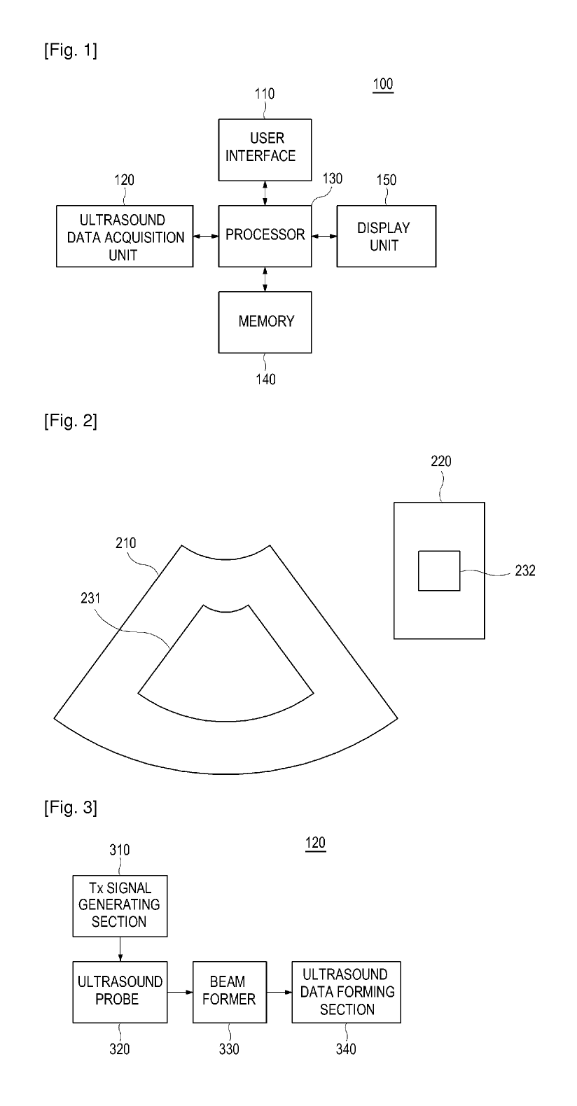

FIG. 1 is a block diagram showing an illustrative embodiment of an ultrasound system. Referring to FIG. 1, the ultrasound system 100 may include a user interface 110, an ultrasound data acquisition unit 120, a processor 130, a memory 140 and a display unit 150.

The user interface 110 may receive input information from a user. In one embodiment, the input information may include a first input information including position and size information of a first region of interest 231, i.e., a color box, set on a brightness mode (B-mode) image 210 and a second input information including position and size information of a second region of interest 232 set on a color map 220, as shown in FIG. 2. The first and second input information are set in various forms by various methods. In one embodiment, the first or second region of interest 231, 232 is set by selecting, such as dragging, a specific region in the B-mode image 210 or the color map 220. In one embodiment, the first or second region of interest 231, 232 is set by using two points set on the B-mode image 210 or the color map 220. The user interface 110 may include a control panel (not shown), a mouse (not shown), a keyboard (not shown) or the like.

The ultrasound data acquisition unit 120 may be configured to transmit and receive ultrasound signals to and from a target object to thereby output ultrasound data of the target object. The ultrasound data acquisition unit 120 may be explained more particularly by referring to FIG. 3.

FIG. 3 is a block diagram showing an illustrative embodiment of the ultrasound data acquisition unit 120. Referring to FIG. 3, the ultrasound data acquisition unit 120 may include a transmit (Tx) signal generating section 310, an ultrasound probe 320 having a plurality of transducer elements (not shown), a beam former 330 and an ultrasound data forming section 340.

The Tx signal generating section 310 may be configured to generate Tx signals. The Tx signal generating section 310 may generate a plurality of Tx signals and apply delays to the Tx signals in consideration of distances between the respective transducer elements and focal points. In one embodiment, the Tx signals may include a first Tx signal for acquiring the B-mode image and a second Tx signal for acquiring a color Doppler mode image.

The ultrasound probe 320 may include the plurality of transducer elements for reciprocally converting between ultrasound signals and electrical signals. The ultrasound probe 320 may be configured to transmit ultrasound signals to the target object in response to the Tx signals provided from the Tx signal generating section 310. The ultrasound probe 320 may further receive ultrasound echo signals reflected from the target object to thereby output the received signals. The received signals may be analog signals. The ultrasound probe 320 may form a first received signal by transmitting and receiving ultrasound signals to and from the target object based on the first Tx signal and form a second received signal by transmitting and receiving ultrasound signals to and from the target object based on the second Tx signal. The ultrasound probe 320 may include a three-dimensional (3D) mechanical probe, a two-dimensional (2D) array probe and the like. However, it should be noted herein that the ultrasound probe 320 may not be limited thereto.

The beam former 330 may be configured to convert the received signals provided from the ultrasound probe 320 into digital signals. The beam former 330 may further apply delays to the digital signals in consideration of distances between the transducer elements and focal points to thereby output digital receive-focused signals. In one embodiment, the beam former 330 may form a first digital signal by analog-to-digital converting the first received signal provided from the ultrasound probe 320 and may further form a first digital receive-focused signal by applying delays to the first digital signal in consideration of distances between the transducer elements and focal points. Also, the beam former 330 may form a second digital signal by analog-to-digital converting the second received signal provided from the ultrasound probe 320 and may further form a second digital receive-focused signal by applying delays to the second digital signal in consideration of distances between the transducer elements and focal points.

The ultrasound data forming section 340 may be configured to form ultrasound data corresponding to a plurality of ultrasound images based on the digital receive-focused signals provided from the beam former 330. The ultrasound data forming section 340 may be further configured to perform various signal processing (e.g., gain adjustment) upon the digital receive-focused signals for forming the ultrasound data. In one embodiment, the ultrasound data forming section 340 may form first ultrasound data based on the first digital receive-focused signal provided from the beam former 330. The first ultrasound data may be radio frequency (RF) data, although it may not be limited thereto. The ultrasound data forming section 340 may further form a second ultrasound data based on the second digital receive-focused signal provided from the beam former 330. The second ultrasound data may be in phase/quadrature phase (IQ) data, although it may not be limited thereto.

Referring back to FIG. 1, the processor 130 is communication with the user interface 110 and the ultrasound data acquisition unit 120. The processor 130 may form the B-mode image and the color Doppler mode image based on the ultrasound data provided from the ultrasound data acquisition unit 120.

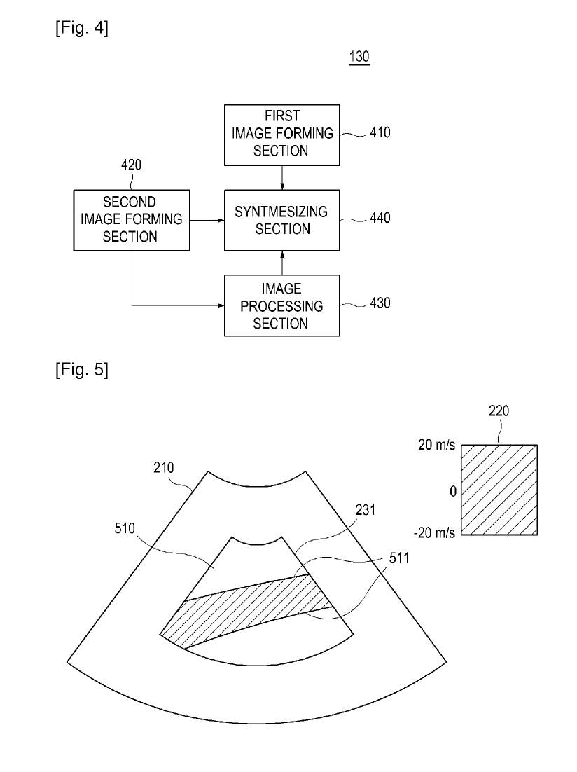

FIG. 4 is a block diagram showing an illustrative embodiment of the processor 130.

Referring to FIG. 4, the processor 130 may include a first image forming section 410, a second image forming section 420, an image processing section 430 and a synthesizing section 440.

The first image forming section 410 may be configured to form the B-mode image 210 in response to the first ultrasound data provided from the ultrasound data acquisition unit 120, as shown in FIG. 2.

The second image forming section 420 may be configured to calculate velocities and power values of the target object (e.g., blood flow) based on the second ultrasound data provided from the ultrasound data acquisition unit 120. It may be further configured to form the color Doppler mode image 510 corresponding to the first region of interest 231 based on the calculated velocities and power values, as shown in FIG. 5. Each pixel of the color Doppler mode image has a color value corresponding to the velocities and power values. Referring to FIG. 5, the reference numeral 511 may represent a vascular wall. The second image forming section 420 may be further configured to determine maximum and minimum velocities from the calculated velocities and form the color map 220 indicating the calculated velocities and power values in a plurality of colors within the maximum and minimum velocities, as shown in FIG. 5

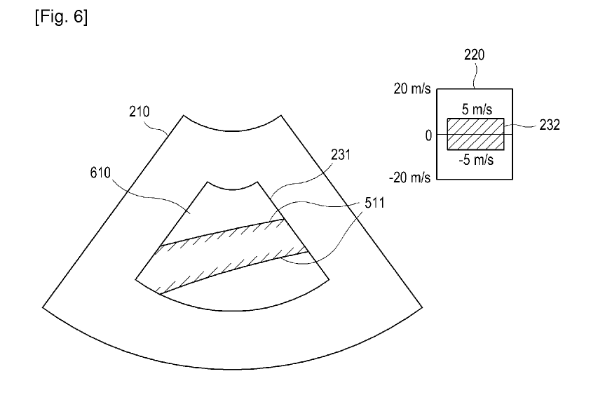

The image processing section 430 may be configured to detect pixels represented by colors corresponding to the second input information provided from the user interface 110 from the color Doppler mode image. The image processing section 430 may be configured to perform image processing upon the color Doppler mode image to indicate only the colors corresponding to the detected pixels, thereby forming an image showing only the colors corresponding to the detected pixels (hereinafter, referred to as “a color reconstruction image”) 610, as shown in FIG. 6. Moreover, the image processing section 430 may be configured to calculate maximum and minimum velocities in the second region of interest 232 by referring to the maximum and minimum velocities of the target object (e.g., blood flow) and form velocity information including the calculated maximum and minimum velocities. In one embodiment, the image processing section 430 may be configured to calculate the maximum velocity (e.g., 5 m/s) and the minimum velocity (e.g., −5 m/s) in the second region of interest 232 by referring to the maximum velocity (e.g., 20 m/s) and the minimum velocity (e.g., −20 m/s) and form the image information including the calculated maximum velocity (e.g., 5 m/s) and minimum velocity (e.g., −5 m/s), as shown in FIG. 6.

The synthesizing section 440 may be configured to form a first synthetic image by synthesizing the B-mode image 210 provided from the first image forming section 410 together with the color Doppler mode image 510 and the color map 220 provided from the second image forming section 420. Also, the synthesizing section 440 may be configured to form a second synthetic image by synthesizing the B-mode image 210 provided from the first image forming section 410 together with the color reconstruction image 610, the color map 220 and the velocity information including the calculated maximum and minimum velocities provided from the image processing section 430.

Referring back to FIG. 1, the memory 140 may be configured to store the ultrasound data, i.e., the first and second ultrasound data, acquired at the ultrasound data acquisition unit 120. Further, the memory 140 may be further configured to store the B-mode image, the color Doppler mode image and the color reconstruction image.

The display unit 150 may be configured to display the first synthetic image formed by the synthesizing section 440. The display unit 150 may be further configured to display the second synthetic image formed by the synthesizing section 440. Also, the display unit 150 may be configured to display the B-mode image formed by the first image forming section 410, the color Doppler mode image formed by the second image forming section 420 and the color reconstruction image formed by the image processing section 430.

Any reference in this specification to “one embodiment,” “an embodiment,” “example embodiment,” “illustrative embodiment,” etc. means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to affect such feature, structure or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An ultrasound system, comprising:
an ultrasound data acquisition unit configured to transmit a ultrasound signal to a target object and receive an echo signal reflected from the target object to acquire ultrasound data;
a user interface configured to receive input information from a user; and
a processor in communication with the ultrasound data acquisition unit and the user interface, the processor being configured to form a color Doppler mode image and a color map by using the ultrasound data, detect pixels corresponding to colors within a region of interest set in the color map from the color Doppler mode image based on the input information and form a color reconstruction image represented by the colors corresponding to the detected pixels.

2. The ultrasound system of claim 1, wherein the color map is a map to indicate the velocities of the target object in terms of colors, the color map being configured to indicate the relative velocities of the target object in the color Doppler mode image.

3. The ultrasound system of claim 1, wherein the input information includes position and size information of the region of interest set upon the color map.

4. The ultrasound system of claim 2, wherein the processor comprising:
an image forming section configured to form the color Doppler mode image and the color map by using the ultrasound data; and
an image processing section configured to detect pixels corresponding to colors of a region of interest set upon the color map from the color Doppler mode image based on the input information and form the color reconstruction image by performing an image processing for representing the colors corresponding to the detected pixels upon the color Doppler mode image.

5. The ultrasound system of claim 3, wherein the image processing section is further configured to:
calculate maximum and minimum velocities corresponding to the region of interest based on the color map;
form velocity information including the maximum and minimum velocities; and
form a synthetic image by synthesizing the color reconstruction image, the color map and the velocity information.

6. A method of providing a color reconstruction image comprising:
a) acquiring ultrasound data of a target object;
b) forming a color Doppler mode image and a color map by using the ultrasound data;
c) receiving input information from a user;
d) detecting pixels corresponding to colors within a region of interest set in the color map from the color Doppler mode image based on the input information; and
e) forming a color reconstruction image represented by the colors corresponding to the detected pixels.

7. The method of claim 6, wherein the color map is a map to indicate the velocities of the target object in terms of colors, the color map being configured to indicate the relative velocities of the target object in the color Doppler mode image.

8. The method of claim 6, wherein the input information includes position and size information of the region of interest set upon the color map.

9. The method of claim 7, further comprising:
f) calculating maximum and minimum velocities in the region of interest based on the color map;
g) forming velocity information including the maximum and minimum velocities; and
h) forming a synthetic image by synthesizing the color reconstruction image, the color map and the velocity information.

10. A computer readable medium comprising instructions that, when executed by a processor performs a color reconstruction image providing method of an ultrasound system, cause the processor to perform steps comprising:
a) acquiring ultrasound data of a target object;
b) forming a color Doppler mode image and a color map by using the ultrasound data;
c) receiving input information from a user;
d) detecting pixels corresponding to colors within a region of interest set in the color map from the color Doppler mode image based on the input information; and
e) forming a color reconstruction image represented by the colors corresponding to the detected pixels.

11. The computer readable medium of claim 10, further comprising:
f) calculating maximum and minimum velocities corresponding to the region of interest based on the color map;
g) forming velocity information including the maximum and minimum velocities; and
h) forming a synthetic image by synthesizing the color reconstruction image, the color map and the velocity information.
